(19) United States
(12) Patent Application Publication
(10) Pub. No.: US 2014/0289027 A1
(43) Pub. Date: Sep. 25, 2014

(54) METHOD OF REUSING SHIPPING AND PACKING MATERIALS

(71) Applicant: Robert Hamm, San Diego, CA (US)

(72) Inventor: Robert Hamm, San Diego, CA (US)

(73) Assignee: Eco Rebox LLC, San Diego, CA (US)

(21) Appl. No.: 14/252,620

(22) Filed: Apr. 14, 2014

Related U.S. Application Data
(63) Continuation of application No. 12/556,482, filed on Sep. 9, 2009.
Application No. 12/556,482 is a continuation-in-part of application No. 12/208,305, filed on Sep. 10, 2008, now abandoned.

(51) Int. Cl. G06Q 10/08

(52) U.S. Cl. CPC G06Q 10/0835
USPC 705/14.1; 705/330; 705/333; 705/35; 705/39

(57) ABSTRACT

A method of reusing a recyclable container comprises receiving information relating to a change in a location of a recyclable container based on a data device situated on the container and causing transfer of a deposit amount based on the change in location. A method of processing reusable materials comprises receiving a reusable packaging material with a data device associated with unique identifier data; associating a condition of the reusable packaging material with the unique identifier data; sorting reusable packaging material to send to manufacturers; and modifying the data associated with said unique identifier data to reflect the number of uses of the container and the destination of the container.

### CROSS-REFERENCE TO RELATED PATENT APPLICATIONS

This application is a continuation of U.S. patent application Ser. No. 12/556,482, filed Sep. 9, 2009, which is a continuation-in-part of U.S. patent application Ser. No. 12/208,305, filed Sep. 10, 2008, which are hereby incorporated by reference in their entirety and for all purposes.

### FIELD OF THE DISCLOSURE

This disclosure relates to systems and methods for reusing recyclable materials used in the manufacture and transportation of goods so that the materials may be used more than once for the same function or purpose. The materials are transferred to and from consumers and transferred to and from manufacturers for use or reuse.

### BACKGROUND OF THE DISCLOSURE

The packaging industry is reportedly the largest consumer of cardboard and plastics and the second largest consumer of polystyrene in the United States. These packaging materials have significant negative impacts on the environment. For example, it has been reported that paper and paperboard products constitute a large portion of the nation's municipal solid waste stream. The production of paper and paperboard products reportedly generates over 1.5 billion gallons of wastewater annually, and over 500 gallons of water are reportedly required to process every tree. In landfill waste, over 1.5 tons of greenhouse gases are reportedly emitted for every ton of paper produced, equivalent to the amount produced if five million cars drove from Seattle to Atlanta. One report regarding paper production states that such production is the third most energy-intensive industry in the United States, consuming 11.5 percent of all of the energy in the industrial sector. Much of the world's paper supply reportedly comes from timber logged in regions with ecologically valuable and biologically diverse habitat.

Plastics and polystyrene usage also negatively affect the environment. It was reported that in 1999, over 13 million tons of plastics, approximately 40% of total plastics, were used for packaging, consuming over 600 billion gallons of water. Expanded polystyrene foam reportedly takes approximately 900 years to decompose in the environment, and polystyrene recycling is reportedly not “closed-loop,” meaning that more resources must be used and more pollution created during its production. In categories of energy consumption, it has been reported that greenhouse gas effects, and total environmental effects, and expanded polystyrene's environmental impacts are only second to aluminum.

### SUMMARY OF THE INVENTION

Packaging materials are an urgent focus for sustainability. Unfortunately, most members of the packaging industry are still adhering to the traditional “4-R” waste management approach (Reduce, Re-use, Recycle, Recover) rather than evaluating and assessing the life cycle impacts of traditional packaging, and rather than developing strategies to reduce the environmental impacts of using traditional packaging materials. As a result, the primary emphasis in trying to avoid environmental impacts still focuses on “down gauging” and “recyclability.” Although the 4-R approach may lead to a minor reduction of environmental impacts in the short term, it does not take into account the need to reduce overall environmental impacts of traditional packaging in a substantial way. In the future, successful packaging systems must minimize the impact on the environment while seamlessly meeting social requirements and expectations.

Embodiments of the present invention relate to an innovative, environmentally conscious, reusable, self-contained shipping system and related methods that replace the need for traditional packaging materials such as corrugated boxes, packing boxes, wood, polystyrene, packing “peanuts,” plastic shrink-wrap, “bubble” wrap, wooden pallets and the like. Product manufacturers may be supplied with reusable containers sets to meet their sustained shipping requirements. Existing manufacturer and other shipping and distribution channels are used to transfer the manufactured products packaged in the reusable containers to the consumer or end user. The consumer may then be offered an incentive or rebate to return the container to a service center for processing and redistribution. The reusable containers may then be transferred to a product manufacturer to complete the present cycle and to be used in a subsequent cycle.

In a first aspect, an embodiment of the present invention includes a method of reusing a recyclable container. A container is made from recyclable materials and provided to product manufacturers for use together with a data device. The data device is previously associated with data pertaining to that container, on or in which the data device is also located. The manufacturers may use the container to hold goods that are shipped to a retail location or otherwise transferred to a consumer or end user. The data associated with the data device is detected and used to determine a deposit to be charged for the container. This charge is separate from the charge the consumer pays for the product inside the container. The transfer of the container to the consumer may take place after the money is transferred to a secure merchant account. Subsequently, the consumer removes the goods from the container and the container is transferred to a service center, optionally with the consumer's contact information. The service center inspects the container to determine if the container can be reused. If the container can be reused, then information regarding its reuse is data that is further associated with the container. If the container is damaged and cannot be reused or repaired, then the container is recycled, and information regarding its disposition is data that is further associated with the container. The service center may optionally send a refund or rebate of the deposit.

In an additional aspect, an embodiment of the present invention includes a method for processing recyclable materials to recover the materials for reuse for the same function, purpose or use. An item each having unique identifier data are associated with a data device attached to or located in the item. The item is subsequently received at a service center, which logs the receipt of the item using the unique identifier and associates that log information with the unique identifier. The service center inspects the item for its condition and determines whether the item should be reused, repaired, refurbished or recycled. Information regarding the condition and destination of the item is then associated with the unique identifier. If the item can be reused, the reusable items are sorted to return to different manufacturers and shipped. Information regarding where an item has been sent and how many times it has been reused is associated with the unique identifier.

### BRIEF DESCRIPTION OF THE DRAWINGS

FIG. 1 illustrates the progress of a container through one cycle of use.

FIG. 2 illustrates a reusable container.

FIG. 3 illustrates a rebate form.

FIG. 4 illustrates a system according to another embodiment of the present invention.

FIG. 5 is a flow chart illustrating the flow of the container and corresponding flow of deposit in accordance with an embodiment of the present invention.

### DETAILED DESCRIPTION OF THE PREFERRED EMBODIMENTS

Embodiments of the present invention relate to an innovative, environmentally conscious, reusable, self-contained shipping system which will reduce the need for traditional packaging materials such as corrugated boxes, packing boxes, wood, polystyrene, packing “peanuts,” plastic shrink-wrap, “bubble” wrap and wooden pallets. Embodiments of the present invention may transform the shipping and packaging infrastructure across various industries by moving away from one-time use, disposable materials to a recycling-based solution with a lifespan of at least ten to fifteen uses. Embodiments of the present invention may apply to anything that is otherwise now packed into a standard or custom sized box, such as refrigerators and appliances, computers, televisions, custom cabinetry, furniture and other household and commercial goods, and can be applied in the residential and commercial moving industries. The end result is the substantial reduction of packaging materials used, a seamless transition in terms of logistics and labor, a profound reduction of negative environmental effects, and a tremendous cost savings.

The citation of documents herein is not to be construed as reflecting an admission that any is relevant prior art. Moreover, their citation is not an indication of a search for relevant disclosures. All statements regarding the date(s) or contents of the documents is based on available information and is not an admission as to their accuracy or correctness.

### GENERAL

Known recycling methods and systems focus on the collection of used packaging materials to be reused as raw materials for new packaging or for entirely different applications. For example, it has been reported that polyethylene bags and reclaimed wood can be reconstituted together to create useful decking and fencing products. Lawn furniture can reportedly be made from “post-consumer” plastic products, such as milk jugs. While such efforts are laudable, in these recycling efforts the “post-consumer” plastic products, for the most part used only once by the consumer, are collected as for recycling, namely reprocessing scrap and waste into a different product.

The present invention extends the life of packaging materials by providing and tracking reusable containers that are designed to be used multiple times for the same or substantially similar purpose or function before the container is recycled. Data regarding the containers are collected during each use of the container by a manufacturer or a consumer. Data devices can be used to identify the location of the container, the manufacturer using the container, the consumer using the container, and the deposit charge for the container. The condition of the container after each use is reviewed, collected and analyzed to determine the disposition of the container.

As described herein, the disclosure includes a method of reusing a recyclable container having an interior compartment to hold goods and an exterior for packaging, labeling or branding when the container is closed. In some embodiments, the container of the disclosure may be completely made from recyclable materials. Non-limiting examples of materials include paper, and plastics, including without limitation polyethylene terephthalate, high density polyethylene and low density polyethylene. In some cases, the containers are primarily made from recyclable materials and any material that cannot be recycled may be easily detached or separated from the recyclable portions of the container.

In many embodiments, each container includes a data device that is situated on or in the container. The data device may comprise or store data that is associated with each container. Non-limiting examples include labels, universal product codes (UPCs), stamps, ink stamps, screen prints, silkscreen prints, heat shrinkable polymer or plastic wrapping, bar codes, radio frequency identification (RFID) tags and non-volatile flash memory devices such as memory cards and flash drives and combinations thereof. In many cases, the data devices may also include other information or decoration such as numbers, letters, words, symbols, figures, designs, pictures and logos as non-limiting examples. Each container may include one or more than one data device. Of course, the present invention is intended to cover any tracking devices or data devices as come within known or customary practice within the art to which the disclosure pertains and as may be applied to the invention.

In some cases, the data devices may be mounted onto an interior or exterior surface of the container with adhesive or with fasteners. In other cases, the data devices are printed, stamped or pressed directly onto an interior or exterior surface of the container. In alternative cases, the data devices may be partially or completely implanted within a portion of the container, such as within a wall of the container. In yet other cases, the data devices may be shrink wrapped onto a portion of the container. In some cases, the data device may be attached to an object that is connected to the container. Non-limiting examples may include a label attached to a paper or plastic tag that is connected to the container with a plastic or cable tie.

In many embodiments, data pertaining to each container is associated with at least one data device located or situated on or in the container. Non-limiting examples of data pertaining to a container include a unique identifier, the amount of a deposit to be charged to the consumer for the container, the number of times or cycles the container has been used, the names of product manufacturers that have used the container, the name and contact information for each consumer that paid a deposit for the container, the amount of any money returned to each consumer, locations where the container has been and the amount and kind of damage experienced by the container.

In some cases, the data device itself comprises the data pertaining to the container. As a non-limiting example, the data device may comprise a label numbered with a unique identifier.

In another example, the data device may comprise a bar code that, when read or scanned, corresponds to a unique identifier for the container or the amount of a deposit to be charged for the container. In yet another example, the data device may comprise shrink wrap over a portion of the container that displays the actual amount of a deposit to be charged for the container. In other cases, the data device contains or stores data pertaining to the container. As a non-limiting example, the data device may comprise an RFID tag that stores a unique identifier for the container, the amount of a deposit to be charged for the container, and the location where the sale took place. The number of kinds and types of data pertaining to the container that are stored on the data device may be limited only by the storage capabilities of the data device. In yet another case, the data device contains or comprises unique identifier data, which is in turn associated with other data pertaining to the container in databases, spreadsheets or other data files, as non-limiting examples. Data pertaining to the container then may be accessed by using the unique identifier to locate data associated with the data device. As a non-limiting example, the unique identifier can be read at the point of sale and used to locate the first amount of money to be charged for the container.

In many cases, the data device may include or be associated with product and other data. As a non-limiting example, a manufacturer's UPC code may be associated with information pertaining to the product in the container as well as with unique identifier data for the container and/or an amount to be charged to the consumer for the container. In this case, the data pertaining to the container may be associated with the data device through a third-party UPC code, and the UPC code can be used to detect or access data, such as unique identifier data, pertaining to the container.

Data pertaining to a container may be detected visually if the nature and location of the data device permits visual inspection. In many cases, the data device must be read by a sensor, reader or scanner designed to read bar codes, UPCs, RFID tags and non-volatile flash memory devices. The data stored in a data device may be subsequently used to detect data pertaining to a container stored in databases, spreadsheets or other data files, as non-limiting examples. A computer system may be used to look up the data pertaining to a container using the data obtained from a data device.

In many embodiments, the container, which optionally contains one or more products or goods, is transferred to a consumer or end user. In some cases, the container may be given to a consumer at a point of sale in connection with the consumer's purchase of the products or goods. Non-limiting examples of a point of sale include retail and wholesale stores, outlets, distribution centers, warehouses and electronic commerce websites. The consumer may be required to pick up the container at a physical location, such as a warehouse or distribution center, that is separate from the point of sale where the purchase is made. Alternatively, the container may be transferred to the consumer via a delivery or shipping service in connection with the consumer's purchase.

In most embodiments, the consumer at the point of sale will pay for the products or goods in the recyclable container, at which time the consumer is also charged a first amount of money for the container. The consumer may pay by cash, credit card or check as non-limiting examples of payment. Of course, the present invention is intended to cover any payment methods as come within known or customary practice within the art to which the disclosure pertains and as may be applied to the invention. The amount paid by the consumer may be contained in a data device on the container that is read at the point of sale, as a non-limiting example. In another non-limiting example, data stored on the data device will be used at a retail store to look up the first amount of money to charge the consumer. In many cases, the first amount of money is a deposit for the container, all or a portion of which is returned, rebated, credited or rewarded back to the consumer when the consumer returns the container. The deposit therefore serves as an incentive to the consumer to encourage him to return the container in good condition for reuse. The amount charged for any given container or recyclable item may vary according to the nature and size of the items.

In many embodiments, the first amount of money paid at the point of sale by a consumer is transferred to a separate account that holds funds collected from the deposits paid by consumers for reusable containers and other reusable items. In many cases, the account will be a trust account. In other cases, the account will be a merchant account. In yet other cases, the account may be an escrow account. Optionally, the container may be transferred to the consumer after the first amount of money is deposited into the separate account.

Embodiments of the disclosed method may include providing to the consumer instructions for returning the container to a service center. In many cases, the instructions will be printed on a form that is placed into the container. The instructions may optionally be printed directly onto a surface of the container. In yet other cases, the instructions will be included in a label or shrink wrap that is placed on an interior or exterior surface of the container.

In other embodiments, the instructions may be included in a rebate form. In many cases, the rebate form may also include a data device associated with unique identifier data. The unique identifier data may be used to obtain or detect data pertaining to the container. The rebate form may optionally include an area on the form on which the consumer may write his contact information such as name, address, telephone number and electronic mail address so that any refund of a deposit may be returned to him. In other cases, the rebate form may further comprise tracking identifier data that is used by a shipping service to track the container during transfer from the consumer to the shipping service, from the shipping service to a service centers, and from a service center to a manufacturer. The tracking identifier data may in some cases be obtained by reading or scanning a bar code printed onto the rebate form. In other cases, the data devices of the container and/or the rebate form optionally store or are associated with the tracking identifier data. In yet other cases, the tracking identifier is a numeric, alphabetic or alphanumeric string.

The rebate form may be placed in the container to be transferred to the consumer. Optionally, the rebate form will be printed by the manufacturer and placed into the container together with the manufacturer's goods and products. In some cases, the rebate form may also be attached to the container using a sleeve or envelope that adheres to an exterior surface of the container. The sleeve or envelope is attached to the container on one side and transparent on the other to allow the rebate form to be viewed and to permit the reading of any bar codes and other information on the rebate form through the plastic sleeve. In many cases, the rebate form will also serve as a shipping form used by the shipping service and/or the consumer in transferring the container.

In some embodiments, the instructions may include a listing of steps that the consumer needs to take to return the container to a service center in order to obtain a rebate, refund or credit of the deposit paid for the container. The instructions may alternatively use or include a reference to a web site where the consumer may obtain the instructions for returning the container and additional information regarding the deposit and rebate program. The instructions may optionally request that the consumer to return the container to a service center or to contact a shipping service that will pick up the container and deliver it to a service center. In some cases the shipping service maybe provided by commercial shipping companies, such as Federal Express as a non-limiting example. The consumer may be required to provide her contact information to the shipping service, which will forward such information to the service center.

As disclosed herein, embodiments of the method may include service centers that receive containers from the consumers, whether directly or via a shipping service. The service centers may include breakdown and refurbishment centers. In some cases, the containers may be received at breakdown centers located in various regional centers throughout the United States. The breakdown centers obtain unique identifier data associated with a container using the data device on the container and logs the receipt of the container in a computer. The breakdown center may examine the container for damage and record the presence or absence of damage as data associated with the container's data device and/or with the container's unique identifier. The breakdown center may also record additional information, such as, without limitation, the number of times or cycles the container has been used, the consumer's contact information, and a second amount of money sent to the consumer.

The breakdown center may flatten the containers to the extent possible for redistribution to a manufacturer, a refurbishment center or to a recycling facility. The containers may be collected on pallets prior to shipment. As described herein, the refurbishment centers of the present inventions may receive containers from the breakdown center and log the receipt of the containers using the data devices on the containers. In some cases, the containers may be examined at the refurbishment center to determine if the container may be reused, and sorted in accordance with the results of the examination. In other cases, the container may be reused for a predetermined number of uses. The predetermined number of uses is data pertaining to the container that is accessible using the container's unique identifier. If the container may be reused, the breakdown center may further determine whether the container should be relabeled for use by a different manufacturer. The container may also be relabeled for use with the same manufacturer as determined by the condition of the label or as determined by manufacturer requirements. The breakdown center revises data associated with the container's data device and with the container's unique identifier to record the disposition of the container.

In some embodiments, a second amount of money is returned to the consumer upon receipt and examination of the container at a service center. The service center inspects the condition of the container and records the findings, which are associated with the container's data device and unique identifier. In some cases, the service center may determine a second amount of money to be returned to the consumer based upon the first amount of money paid by the consumer less an amount deducted for damage to the container. In additional cases, the second amount of money may also be reduced relative to the first amount of money by a handling fee and/or a shipment fee for the consumer's use of a shipping service. Of course, in the alternative the consumer may pay the shipment fee separately and directly to the shipping service. In many cases, the second amount of money is paid to the consumer by the service center using information associated with the rebate form. Such payment may take the form of a check, credit slip or credit to the consumer's credit card account. In other cases, the consumer may be instructed to request payment through a secure Internet web site. The monies used to pay the consumer may be drawn from the secure account.

As described herein, the disclosure includes a method of processing reusable materials using unique identifier data that is associated with each item and a data device situated on or in the item. In some embodiments, a service center logs in the receipt of an item using the unique identifier data. The service center may inspect the item to determine the amount of damage experienced by the item. This information is associated with the item's unique identifier. The service center also revises data pertaining to the item, such as incrementing by one the number of times or cycles the item has been used. The service center may determine whether the item is reusable or whether the item can no longer be used and therefore should be recycled. The disposition of the item is modified in the computing system used by the service center for each item. As a non-limiting example, a reusable item may be directed to a manufacturer based on the number of times or cycles the item has been used, the manufacturer's production requirements and the number of available items at the service center. The service center sorts the reusable items and relabels the items if necessary, and flattens or otherwise prepares the items for redistribution.

Having now generally provided the disclosure, the same will be more readily understood through reference to the following examples which are provided by way of illustration, and are not intended to be limiting of the disclosure, unless specified.

### EXAMPLES

### Example 1

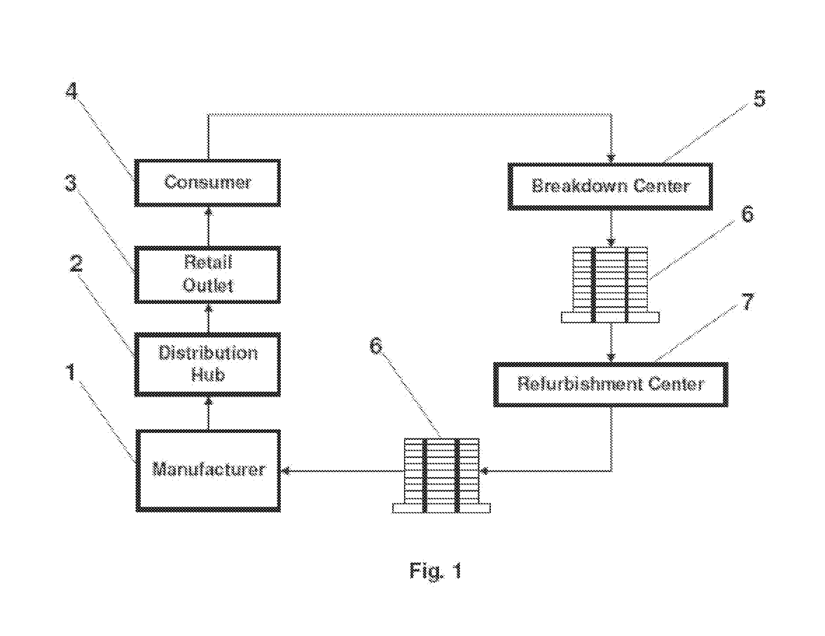

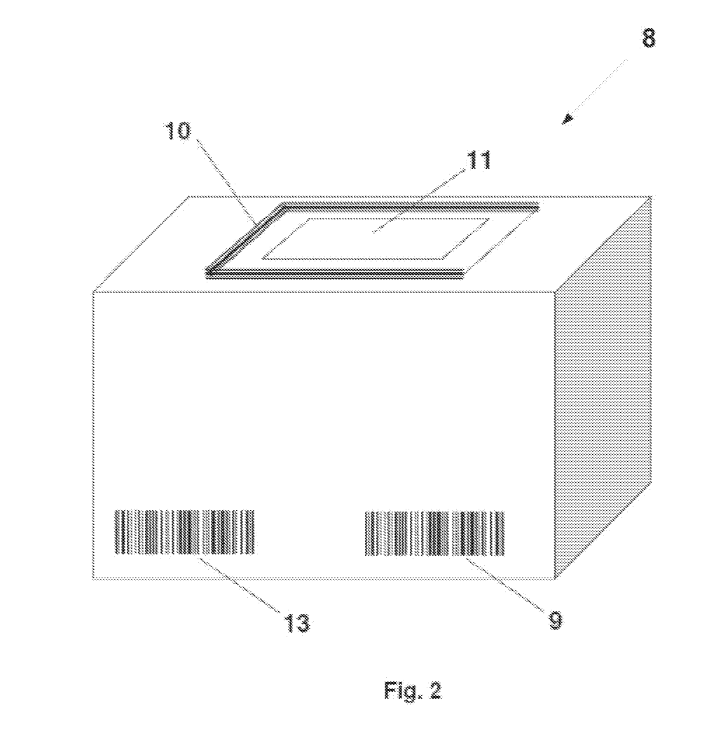

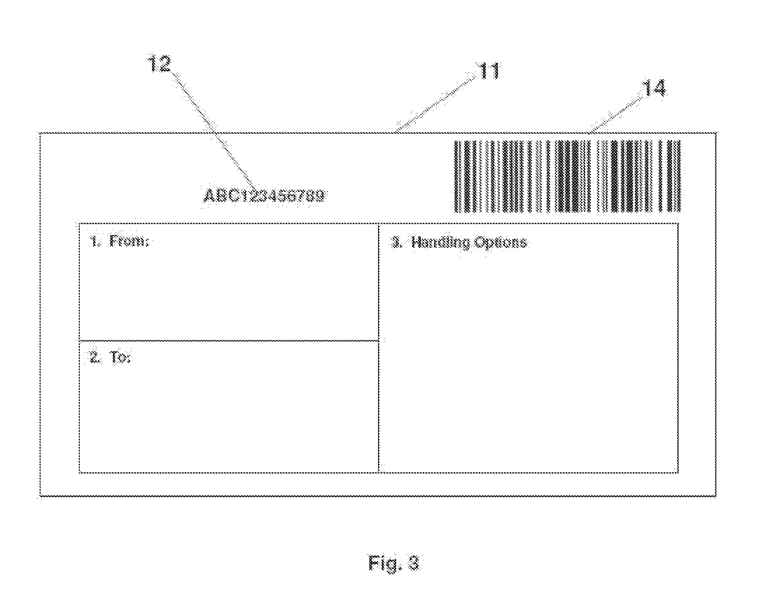

In FIG. 1, box 8 of FIG. 2 made from recyclable materials and designed to hold televisions during shipment is received at manufacturer 1. The box includes bar code labels 9 and 13 on the exterior of the box. The bar code label 9 has been previously associated with unique identifier data that is obtained when the bar code is read or scanned. The bar code label 13 has been previously associated with a deposit amount that should be charged for the box, also obtained when the bar code is read or scanned. The manufacturer 1 scans the bar code on label 9 and prints a rebate form 11 with bar code label 14, which is a duplicate of bar code label 9. The rebate form 11 also includes tracking identifier data 12 as shown in FIG. 3. The rebate form is placed into the box 8 along with an instruction sheet for returning the container. Alternatively, the rebate form may be provided directly to retail outlet 3.

The manufacturer packs a television into box 8 and transfers the television to a distribution hub 2. The television is transferred from distribution hub 2 to a retail outlet 3 through existing distribution channels. Consumer 4 selects the television for purchase and proceeds to the point of sale at retail outlet 3 to pay for the product. At the point of sale, the bar code on label 13 is scanned and the deposit amount is added as an additional charge to the consumer. Consumer 4 pays for both the television and the deposit on the box at the point of sale with a credit card, after which she leaves with the television in its box. Retail outlet 3 transfers the deposit amount to a secure trust account. Retail outlet 3 may optionally scan the bar code on label 9 and forward the unique identifier data to the breakdown center 5 or the refurbishment center 7 to alert the service centers that a deposit has been made.

In another embodiment, the consumer may purchase the product from an online retailer. In this regard, the distribution hub 2 and the retail outlet 3 may be a single entity which serves as the distributor for online sales.

Consumer 4 removes the television, rebate form 11, instructions and an optional sleeve or envelope 10 from box 8. The instructions indicate that the consumer should (i) call a shipping service for pick up of the box, for which service a fee is deducted from the consumer's deposit; (ii) take the box to an office of the shipping service or other designated collection center; or (iii) return the box to a breakdown center 5. In the case of (i) or (ii), the box may be collected by an intermediary (not shown in the figures) before being taken to the breakdown center 5. The instructions indicate that if the consumer chooses (ii) and (iii), no deductions will be taken from the consumer's deposit. Optionally, the instructions indicate that a handling fee may be deducted from the consumer's deposit.

Consumer 4 calls the shipping service to pick up box 8 and writes her name and contact information on rebate form 11. The shipping service scans in the bar code on label 9 and enters its tracking identifier data 12 into its computer system. The shipping service may optionally determine the closest regional breakdown center 5 and put that location on rebate form 11. The shipping service places the envelope 10, using the adhesive provided on one side of the envelope, onto the exterior of the box and puts rebate form 11 into the envelope, which is transparent on the side facing away from the box. The shipping service may forward the unique identifier data to the breakdown center 5 or the refurbishment center 7 to alert the service centers that box 8 has been picked up. The shipping service uses the tracking identifier data 12 to track the box from the consumer to breakdown center 5 or refurbishment center 7. The shipping service optionally forwards the name and contact information of consumer 4 to breakdown center 5 or refurbishment center 7.

The shipping service optionally may flatten or collapse the box to prepare the box 8 for shipment to breakdown center 5 or the refurbishment center 7. Optionally, the shipping service may collect multiple boxes to ship together. The shipping service may optionally collect the boxes on a pallet 6 prior to shipment, or collect the boxes in a shipping container. Non-limiting examples of shipping containers may include LD2 and LD3 containers or custom containers of a suitable size and dimension to collect multiple boxes.

The breakdown center 5 receives box 8 from the shipping service and scans in the bar code on label 9 or label 13. The breakdown center accesses data pertaining to the box using the unique identifier data and increases the number of cycles that the box has been used by one. The breakdown center logs in the receipt of the box and proceeds to inspect the box for damage. If the box may be reused, either as is or with refurbishment, then the breakdown center may flatten or collapse the box in preparation for shipment with other boxes on pallet 6 to refurbishment center 7. The breakdown center 5 may optionally send the box to a recycling center as scrap if the box cannot be reused. The breakdown center 5 may modify data pertaining to the box and associate that data with the box's unique identifier. The breakdown center 5 or refurbishment center 7 may optionally send a check returning the deposit paid by consumer 4 less a handling fee and less a shipping service fee. Alternatively, breakdown center 5 or refurbishment center 7 may optionally credit the credit card account of consumer 4 in response to an electronic refund request submitted by consumer 4 over the Internet in accordance with the instructions sheet.

The refurbishment center 7 receives box 8 from the breakdown center 5 and scans in the bar code on label 9. The refurbishment center 7 accesses data pertaining to the box using the unique identifier data, including any data that has been modified by the breakdown center 5. The refurbishment center 7 sorts the box 8 according to the information provided by breakdown center 5, or optionally the refurbishment center 7 conducts its own inspection. The refurbishment center 7 may relabel a box for reuse with the same or a different manufacturer. The refurbishment center 7 may designate a box for recycling if the box has reached a predetermined number of cycles of use. The refurbishment center 7 may modify data pertaining to the disposition of the box and associate that data with the box's unique identifier. Refurbishment center 7 sorts box 8 according to the disposition. As an example, the refurbishment center 7 may relabel box 8 for use by manufacturer 1 and collect the box with other boxes on a pallet 6 for shipment to manufacturer 1.

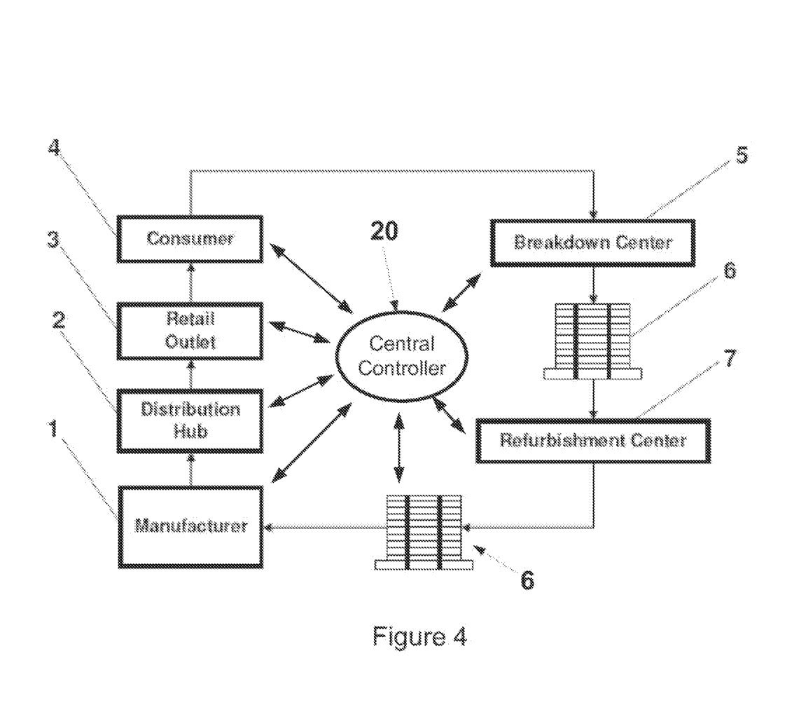

Referring now to FIG. 4, a centralized entity 20 may be provided to manage the flow of the container, including tracking its location and distribution of the deposit associated with the container. In this regard, the central entity 20 may be able to track the location of the container through, for example, bar code scanning of the container by one or more entities. For example, the central entity 20 may be able to determine the location of the container through bar code scans performed by the manufacturer 1 upon receipt of the container, by the distribution hub 2 upon receipt or discharge of the container, etc. In the case of an online purchase by the consumer 4, the tracking of the container may be continued through bar code scans by the delivery organization (e.g., UPS, FedEx, etc.). Thus, the central entity 20 may be able to track when the consumer 4 has possession of the container and when the consumer 4 releases possession of the container to, for example, a collection center, where another bar code scan may be performed.

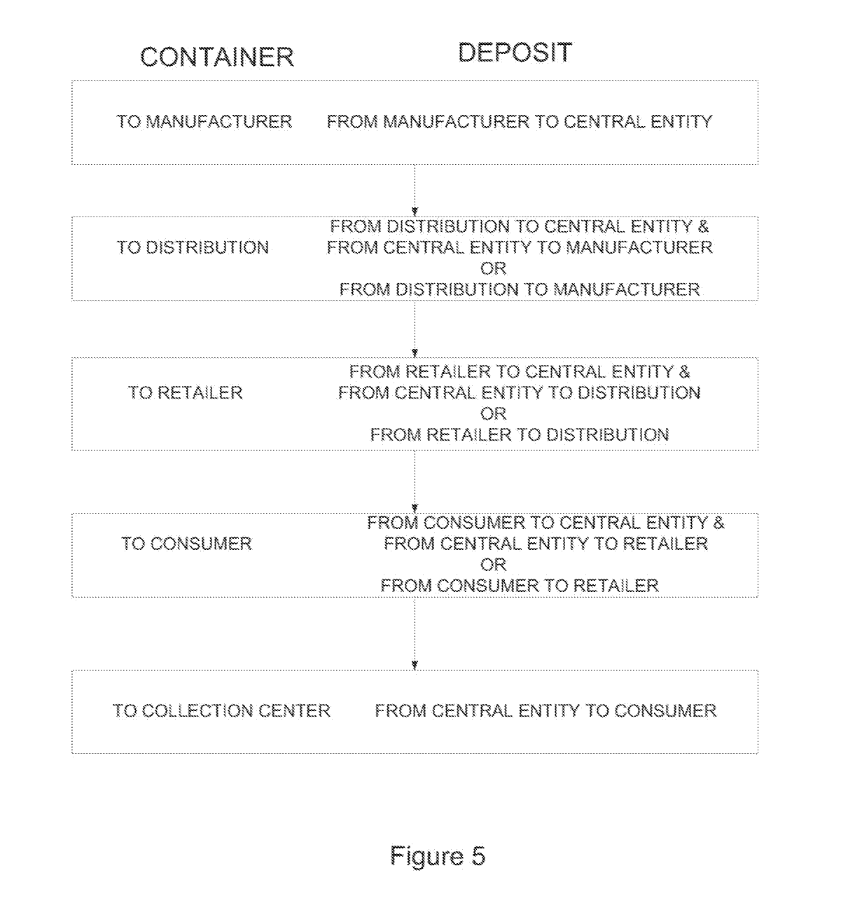

Further, the central entity 20 may be configured to control the flow of the deposit by collecting and distribution the deposit based on the tracking of the container. In this regard, FIG. 5 illustrates an example flow of the deposit. Of course, those skilled in the art will understand that the deposit amount may be transferred through cash or other means, such as an account which may be credited or debited.

Referring now to FIG. 5, in one embodiment, when the container is delivered to the manufacturer, the deposit amount may be collected by the central entity from the manufacturer. When the container is transferred by the manufacturer to the distribution hub, the deposit amount may be transferred from the distribution hub to the manufacturer. This may be achieved through a direct transaction between the distribution hub and the manufacturer or through two separate transactions: one between the distribution hub and the central entity, and another between the central entity and the manufacturer. In the case of a direct transaction between the distribution hub and the manufacturer, the central entity may be notified of the transaction.

Similar flow may occur at each point of the cycle. When the consumer receives the container, the consumer may pay the deposit amount to the retailer or to the central entity, preferably indirectly through the retailer. In this regard, the consumer may interact only with familiar entities such as the retailer. In one embodiment, the consumer may be given the option of returning the container to a collection center which is affiliated with the central entity. In this regard, the consumer may receive the deposit from the central entity.

Of course, at each step of the flow, amount of the deposit that is transferred may vary on, for example, the condition of the container.

All references cited herein, including patents, patent applications, and publications, are hereby incorporated by reference in their entireties, whether previously specifically incorporated or not.

Having now fully described the inventive subject matter, it will be appreciated by those skilled in the art that the same can be performed within a wide range of equivalent parameters, concentrations, and conditions without departing from the spirit and scope of the disclosure and without undue experimentation.

While this disclosure has been described in connection with specific embodiments thereof, it will be understood that it is capable of further modifications. This application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth.

What is claimed is:

1. A reusable shipping container system comprising:
one or more reusable shipping containers having an interior compartment sized to hold one or more goods and an exterior surface;
a data device coupled to each reusable shipping container, the data device being configured to store unique data associated with each reusable shipping container, the unique data including at least a deposit paid for using the reusable shipping container; and
a centralized controller in communication with the data device of the one or more reusable shipping containers, the centralized controller being configured to receive the unique data from the data device for each reusable shipping container to manage the transfer of the one or more reusable shipping containers between at least two or more locations.

2. The system of claim 1, wherein the at least two or more of locations is selected from the group consisting of a manufacturer, a distributer, a wholesaler, a retailer, a consumer and a collection center.

3. The system of claim 1, wherein the centralized controller is configured to control the flow of the deposit by collecting and distributing the deposit between the locations based on tracking of the reusable shipping container.

4. The system of claim 3, wherein the location may receive be a rebate, refund or credit for the deposit for the reusable shipping container.

5. The system of claim 3, wherein the deposit is held in an escrow account.

6. The system of claim 1, wherein the unique data includes the number of uses of the reusable shipping container.

7. The system of claim 6, wherein the unique data includes the condition of the reusable shipping container after each use.

8. The system of claim 1, wherein the centralized controller may include a computer system having databases, spreadsheets or other data files containing received data for each reusable shipping container.

9. The system of claim 1, wherein the one or more reusable shipping containers is made from recyclable materials.

10. A method of managing the use of a reusable shipping container comprising:
paying a deposit for a reusable shipping container having a data device coupled to the reusable shipping container;
receiving information from the data device with a centralized controller configured to track the location of the reusable shipping container and the deposit associated with the reusable shipping container;
packaging goods or products for shipping within an interior compartment of a reusable shipping container;
shipping the reusable shipping container between at least two or more locations;
removing the goods or products from the reusable shipping container; and
returning the reusable shipping container.

11. The method of claim 10, further comprising transferring at least a portion of the deposit from one location to another location.

12. The method of claim 11, wherein the at least a portion of the deposit is calculated as the deposit paid less at least one of a handling fee, a shipping service fee, and an amount deducted for damage to the reusable shipping container.

13. The method of claim 11, wherein the location may receive be a rebate, refund or credit for the at least a portion of the deposit.

14. The method of claim 10, wherein the deposit is held in an escrow account.

15. The method of claim 10, wherein the at least two or more of locations is selected from the group consisting of a manufacturer, a distributer, a wholesaler, a retailer, a consumer and a collection center.

16. The method of claim 10, wherein the centralized controller may include a computer system having databases, spreadsheets or other data files containing received information for the reusable shipping container.

17. A method of reusing a reusable shipping container comprising
detecting information pertaining to a reusable shipping container having a data device with a centralized controller;
using the information to determine a deposit charged for the reusable shipping container;
shipping the reusable shipping container between at least two locations;
transferring the deposit from one location to another location;
reviewing the condition of the reusable shipping container when shipping is complete to determine if the container should be reused or recycled, and further determine if at least a portion of the deposit should be returned.

18. The method of claim 17, wherein transferring the deposit comprises transferring at least a portion of the deposit from one location to another location.

19. The method of claim 18, wherein the at least a portion of the deposit is calculated as the deposit paid less at least one of a handling fee, a shipping service fee, and an amount deducted for damage to the reusable shipping container.

20. The method of claim 17, wherein the at least two or more of locations is selected from the group consisting of a manufacturer, a distributer, a wholesaler, a retailer, a consumer and a collection center.
